(19) United States
(12) Patent Application Publication
(10) Pub. No.: US 2008/0190456 A1
(43) Pub. Date: Aug. 14, 2008

(54) Device and Method for Cleaning and Examining the Holes of

(75) Inventor: Jurgen Heller, Dassendorf (DE)

Correspondence Address: K.F. ROSS P.C., 5683 RIVERDALE AVENUE, SUITE 203 BOX 900, BRONX, NY, 10471-0900, US

(73) Assignee: M.O.M. TOOLS, LLC, SHAKER HEIGHTS (OH)

(21) Appl. No.: 11/885,176

(22) PCT Filed: Jan. 19, 2006
(86) PCT No.: PCT/EP06/00428

§ 371 Date: Mar. 3, 2008

(30) Foreign Application Priority Data
Feb. 24, 2005 (DE) 10-2005-008-413.3

(51) Int. Cl. B08B 9/027; G01N 21/88; B08B 13/00

(52) U.S. Cl. 134/22.11; 356/241.1; 134/44

(57) ABSTRACT

Described are an apparatus and a method for examining the holes in a nozzle strip, in which are provided a unit for cleaning the nozzle strip and a unit that is connected thereto and used to automatically detect the state of the nozzle holes, the holes being automatically examined for impurities and/or signs of wear by use of optical methods and optionally subjected to complete or partial aftercleaning.

The invention relates to an apparatus and a method for cleaning and examining the holes in a nozzle strip to allow detection and elimination of any impurities and/or signs of wear.

It is known that water-jet consolidation of staple fibers or continuous fibers represents one of the most interesting and promising consolidation methods for nonwoven fabric materials. The process of water-jet consolidation is based on the mingling of the individual fibers by means of a plurality of very fine water jets. These water jets are generated by uniformly distributing water under high pressure over the length of the unit in a nozzle beam, and guiding the water through the individual nozzle holes of an internal nozzle strip. The water jets thus generated, having a diameter of 0.08 to 0.15 mm, strike the nonwoven fabric at a speed of 100 to 350 m/s, thereby condensing and mingling the fibers.

The nozzle strips are subjected to extreme mechanical-chemical stress. Depending on the pressure, fibers, and water quality, significant reductions in the expected useful life frequently result due to abrasion, cavitation, and chemical reactions. An optimized nozzle geometry ensures a perfect impingement by the water jet, thereby achieving very high conversion efficiencies of water pressure energy into turbulence.

Good consolidation of very light (10 g/m²) as well as very heavy (>500 g/m²) nonwoven fabrics may be achieved by efficient pretreatment of the nonwoven fabric. For this purpose, drum-belt compacting with integrated prewetting and consolidation is very well suited for all weight and speed ranges. In combination with multistage consolidation on the drums as well as belts, followed by high-powered dewatering, practically all nonwoven fabrics may be processed for various applications.

Short down times in a spunlace facility are of critical importance for economic reasons. Cost-effectiveness calculations have shown that a 10% reduction in down time may increase production of the facility by as much as 30%. The filtration. technology used for cleaning the circulation water has the greatest effect on down times. By use of modern filtration technology the cleaning intervals for the nozzle strips may be extended to periods as long as two weeks.

Uniformly high quality of the spun-bond nonwoven fabric produced using spunlace technology depends primarily on a reliable and malfunction-free water-jet consolidation of the nonwoven fabrics. This can be ensured only when the nozzle holes in the nozzle strip used for the water-jet consolidation are free of obstructions and show no signs of wear. An apparatus for examining one or more nozzles and cleaning of same is known from DE 102 13 014. The state (degree of calcination) is automatically detected by optical detectors, and triggers cleaning, for example by ultrasound or other cleaning methods. It is also known from DE 600 06 258 T2 [U.S. Pat. No. 6,824,614] to provide a gumming apparatus for a cigarette packaging machine that has supply devices for the adhesive that may become plugged during drying and that must therefore be cleaned. Also known from DE 102 03 719 [US 2005/0219505] is a facility for water-jet consolidation of nonwoven fabric materials where the holes in a nozzle strip are monitored by optical means and then cleaned as needed. However, there continues to be great interest in an apparatus and a method for automatically and reliably examining the holes in a nozzle strip.

The invention therefore relates to an apparatus for examining the holes in a nozzle strip in a facility for water-jet consolidation of nonwoven fabric materials, comprising a unit for the single or multiple water jet cleaning of the nozzle strip, and a unit that is connected thereto and equipped with optical means for the continuous automatic detection of the state of the nozzle holes, and, if plugging or impurities are identified after the examination, the nozzle strip is subjected to complete or partial aftercleaning.

The cleaning unit preferably comprises a container for soaking the nozzle strip in a liquid, from which the nozzle strip may be extracted and fed via transport rollers to a unit for water jet and ultrasonic cleaning.

The unit for automatically detecting the state of the nozzle holes advantageously identifies any foreign matter in the nozzle holes as well as any signs of wear to the nozzle edges.

The invention further relates to a method for examining the state of the holes in a nozzle strip in a facility for water-jet consolidation of nonwoven fabric materials where the nozzle strip is first subjected to single or multiple water jet cleaning, and the holes are then automatically examined for impurities and/or signs of wear by optical methods, and, if impurities or plugging are identified, the nozzle strip is subjected to complete or partial aftercleaning.

The continuous and automatic examination of the condition of the holes in a nozzle strip has thus taken on increasingly greater importance due to the fact that production speeds of spun-bond nonwoven fabrics are currently as high as 500 m/min, so that substandard quality of a large volume of product may result within a very short time if needling is inadequate. However, uniformly high product quality may be ensured when the holes in the nozzle strip are automatically monitored on a continuous basis. Continuous examination of the holes in the nozzle strip therefore has a crucial influence on the reliability of the entire facility and the quality of the product thus manufactured.

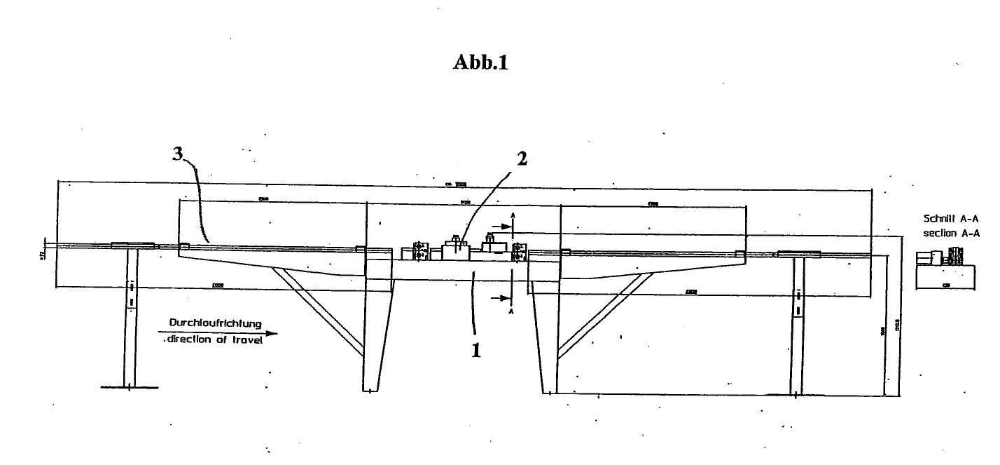

FIG. 1 shows a partial view of the apparatus according to the invention, in which the nozzle strips to be examined are led through a unit that allows automatic detection of the state of the nozzle holes. The following details are identified therein:

### LIST OF REFERENCE NUMERALS

1 Apparatus for examining the nozzle strip

2 Optical devices for evaluating the nozzle holes

3 Transport apparatus for the nozzle strips

1. An apparatus for examining the holes in a nozzle strip in a facility for water-jet consolidation of nonwoven fabric materials, comprising:
means for the single or multiple water jet cleaning of the nozzle strip, and
means connected thereto and equipped with optical means for the continuous automatic detection of the state of the nozzle holes, and, if plugging or impurities are identified after the examination, for subjecting the nozzle strip to complete or partial aftercleaning.

2. The apparatus according to claim 1 wherein the cleaning means comprises a container for soaking the nozzle strip in a liquid, from which the nozzle strip may be delivered via transport rollers to means for water jet and ultrasonic cleaning.

3. The apparatus according to claim 1 wherein the means for automatically detecting the state of the nozzle holes identifies any impurities in the nozzle holes as well as any signs of wear to the nozzle edges.

4. A method for examining the state of the holes in a nozzle strip in a facility for water-jet consolidation of nonwoven fabric materials, in which the nozzle strip is first subjected to single or multiple water jet cleaning, and the holes are then automatically examined for impurities and/or signs of wear by optical methods, and if impurities or plugging are identified the nozzle strip is subjected to complete or partial aftercleaning.
